(19) United States
(12) Patent Application Publication
(10) Pub. No.: US 2012/0254729 A1
(43) Pub. Date: Oct. 4, 2012

(54) WEB PAGE ELEMENT PRESENTING METHOD AND SYSTEM

(75) Inventor: YONG WAN, Beijing (CN)

(73) Assignee: BEIJING SOGOU TECHNOLOGY DEVELOPMENT CO., LTD., Beijing (CN)

(21) Appl. No.: 13/495,338

(22) Filed: Jun. 13, 2012

Related U.S. Application Data
(63) Continuation of application No. PCT/CN2010/080452, filed on Dec. 29, 2010.

(30) Foreign Application Priority Data
Dec. 30, 2009 (CN) 200910244559.8

(51) Int. Cl. G06F 17/00

(52) U.S. Cl. 715/234

(57) ABSTRACT

A method is disclosed for presenting page elements on a computer having a browser for a user of the computer. The method includes identifying a page element in a web page displayed in a browser window of the browser as a target page element and modifying a coordinate type of the target page element. The method also includes presenting the target page element at a fixed position relative to the browser window based on the modified coordinate type.

### CROSS-REFERENCES TO RELATED APPLICATIONS

This application claims the priority of PCT patent application no. PCT/CN2010/080452, filed on Dec. 29, 2010, which claims the priority of Chinese patent application no. 200910244559.8, filed on Dec. 30, 2009, the entire contents of all of which are incorporated herein by reference.

### FIELD OF THE INVENTION

The present invention generally relates to web browser technologies and, more particularly, to the methods and systems for presenting page elements in a web page.

### BACKGROUND

Network resources are provided to the user through web pages and in the form of page elements. The utilization rate of the resources not only is reflected in the hits of the web pages, but also needs to take into account whether specific page elements are truly browsed or listened by users. Otherwise, even if a web page has a high hit rate, it still possible that only part of the network resources in the web page have a high utilization rate.

In general, when a page element in a web page is presented or displayed, the page element is directly presented or displayed on a specified location in the web page. For example, when a user wants to watch a video in the web page, usually the video is directly played for the user at the location where the video is embedded in the web page. As shown in FIG. 5A, a video 502 is located at upper left corner of the browser window, and the video 502 is also in the viewable area of the browser window.

However, if the user wants to browse other contents of the web page and scrolls the scroll bar, the video may be no longer displayed in the viewable area of the browser window. For example, for the page displayed in FIG. 5A, when the scroll bar scrolls down, the page may be displayed as shown in FIG. 5B. As shown in FIG. 5B, only a portion of video 502 remains visible in the viewable area of the browser window. When the scroll bar scrolls further down, the video 502 may be completely out of the user's view. That is, it may be very inconvenient or impractical for the user to browse the contents of the web page while watching the video in the web page. Thus, the utilization rate of the network resources is reduced.

The disclosed methods and systems are directed to solve one or more problems set forth above and other problems.

### BRIEF SUMMARY OF THE DISCLOSURE

One aspect of the present disclosure includes a method for presenting page elements on a computer having a browser for a user of the computer. The method includes identifying a page element in a web page displayed in a browser window of the browser as a target page element and modifying a coordinate type of the target page element. The method also includes presenting the target page element at a fixed position relative to the browser window based on the modified coordinate type.

Another aspect of the present disclosure includes a system for presenting page elements to a user using a browser. The system includes a target identification unit and a fixed presentation unit. The target identification unit is configured to identify a page element in a web page displayed in a browser window of the browser as a target page element. The fixed presentation unit is configured to modify a coordinate type of the target page element and to present the target page element at a fixed position relative to the browser window based on the modified coordinate type.

Other aspects of the present disclosure can be understood by those skilled in the art in light of the description, the claims, and the drawings of the present disclosure.

### BRIEF DESCRIPTION OF THE DRAWINGS

FIG. 1A illustrates an exemplary network environment incorporating certain aspects of the disclosed embodiments;

FIG. 1B illustrates a block diagram of an exemplary user computer consistent with the disclosed embodiments;

FIG. 2 illustrates an exemplary process for presenting page elements consistent with the disclosed embodiments;

FIGS. 3A-3B illustrate an exemplary page element presentation method consistent with the disclosed embodiments;

FIG. 4 illustrates an exemplary page element presentation system consistent with the disclosed embodiments; and

FIGS. 5A-5B illustrate a conventional page element presentation method.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

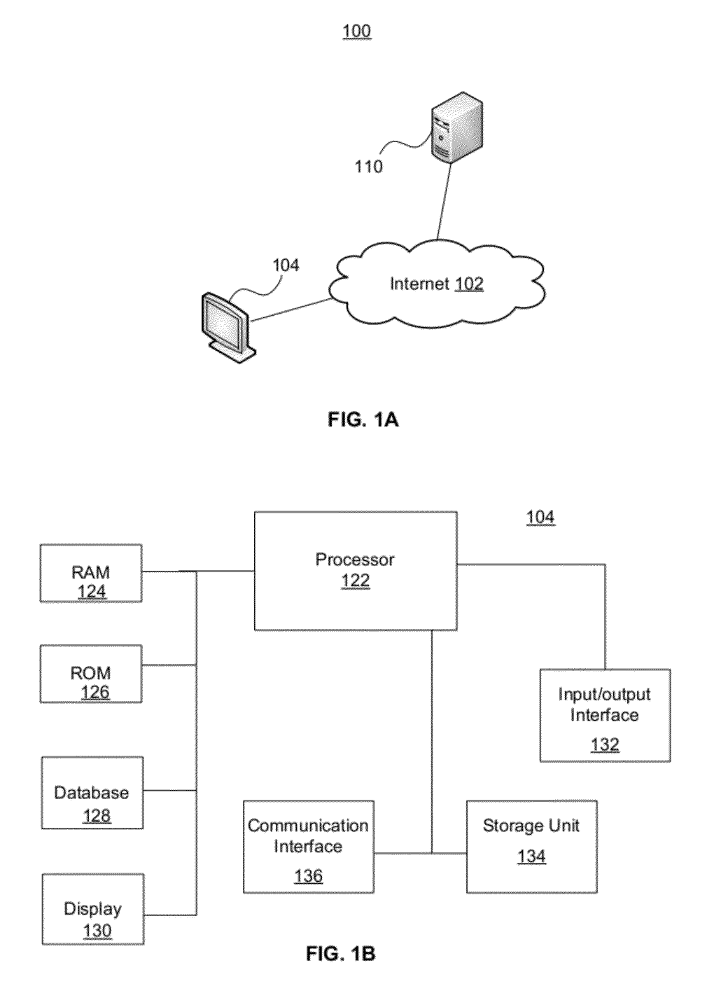

FIG. 1A illustrates an exemplary network environment incorporating certain aspects of the disclosed embodiments. As shown in FIG. 1A, network environment 100 may include the Internet 102, a user computer 104, and a server 110. Other components may be added and certain devices may be removed without departing from the principles of the disclosed embodiments.

The Internet 102 may include any private and public computer networks interconnected using the standard transport control protocol/internet protocol (TCP/IP). Internet 102 may carry a large number of services over IP, such as the inter-linked hypertext markup language (HTML) documents of the World Wide Web (WWW). Internet 102 may connect a large number of websites.

Server 110 may include any appropriate computer servers, software, and databases so as to provide various websites and web pages. Further, user computer 104 may include any appropriate types of computers operated by a user or users to access web-based or local web pages. For example, user computer 104 may include a desktop computer, a notebook computer, a tablet, a smart phone, and other types of computing platforms and software programs. FIG. 1B shows a block diagram of an exemplary user computer 104.

As shown in FIG. 1B, user computer 104 may include a processor 122, a random access memory (RAM) unit 124, a read-only memory (ROM) unit 126, a database 128, a display 130, an input/output interface unit 132, a storage unit 134, and a communication interface 136. Other components may be added and certain devices may be omitted without departing from the principles of the disclosed embodiments.

Processor 122 may include any appropriate type of graphic processing unit (GPU), general-purpose microprocessor, digital signal processor (DSP) or microcontroller, and application specific integrated circuit (ASIC), etc. Processor 122 may execute sequences of computer program instructions to perform various processes associated with user computer 104. The computer program instructions may be loaded into RAM for execution by processor 122 from ROM or FLASH memory.

Database 128 may include any appropriate commercial or customized database to be used by user computer 104, and may also include query tools and other management software for managing database 128. Display 130 may include any appropriate computer monitor, such as an LCD monitor. Further, input/output interface 132 may be provided for a user or users to input information into user computer 104 or for the user or users to receive information from user computer 104. For example, input/output interface 132 may include any appropriate input device, such as a remote control, a keyboard, a mouse, a microphone, a video camera or web-cam, an electronic tablet, voice communication devices, or any other optical or wireless input devices. Input/output interface 132 may include any appropriate output device, such as a speaker, or any other output devices.

Storage unit 134 may include any appropriate storage device to store information used by user computer 104, such as a hard disk, a flash disk, an optical disk, a CR-ROM drive, a DVD or other type of mass storage media, or a network storage. Further, communication interface 136 may provide communication connections such that user computer 104 may be accessed remotely and/or communicate with other systems through computer networks or other communication networks via various communication protocols, such as TCP/IP, hyper text transfer protocol (HTTP), etc.

User computer 104 may access various web pages from server 110 through Internet 102 or from local storages. When accessing a web page, user computer 104 may display or present the web page in a web browser window or other type of window. More particularly, user computer 104 may display or present various page elements of the web page.

A page element, as used herein, may refer to any video, audio, picture, animation including GIF animation or flash animation, text, or any combination of two or more thereof. The page element can also include any type of element discovered or used in the future. A video element may be different from an animation element in that the video element includes streaming media played in a player embedded in the web page while the animation element is similar to picture and text element, such as some Flash ads in the web page, etc.

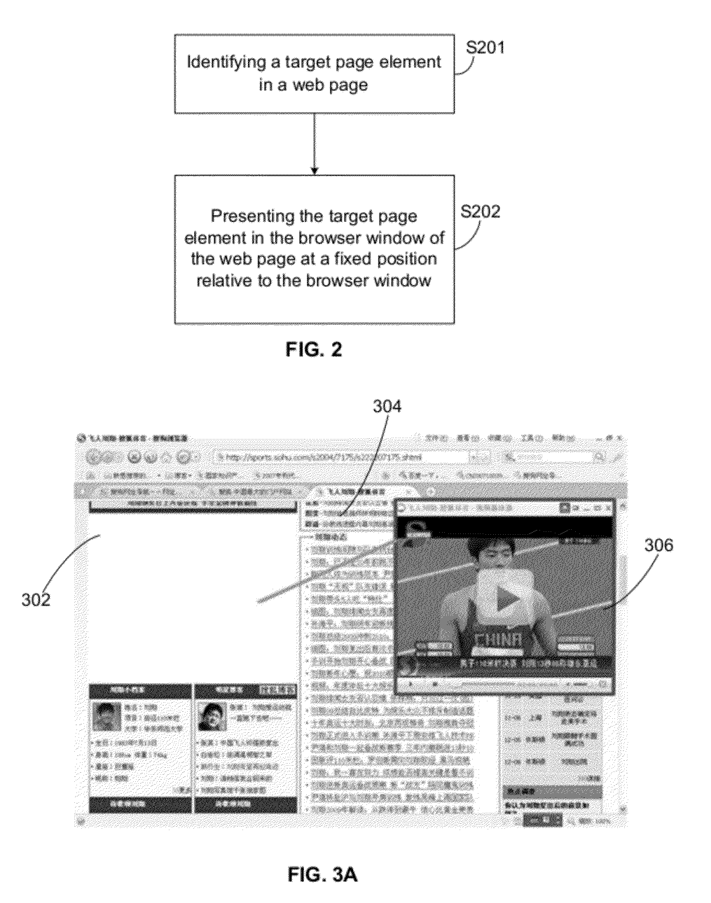

In operation, user computer 104 may be configured to present various page elements of web pages to a user or users of user computer 104. More particularly, user computer 104 may use certain software and/or hardware to present (e.g., to display, play, or interact) the various page elements to the user. FIG. 2 illustrates an exemplary process for presenting page elements performed by computer 104 or processor 122.

As shown in FIG. 2, at the beginning, processor 122 may identify a target page element in a web page (S201). Processor 122 may identify the target page element in various ways. For example, processor 122 may automatically identify the target page element. More specifically, the type or types of page elements that need to be presented may be pre-configured. The browser may then identify the type of each page element in the web page, and automatically determines that a page element having the pre-configured type is the target page element.

For example, if the pre-configured type is a video element, when the browser identifies a video element in the web page, the browser can directly determine that the video element is the target page element.

To avoid interfering with the user's normal browsing activities, after identifying a page element of the pre-configured type in the web page, the browser may optionally provide the user with an entrance to present the element of the pre-configured type. The entrance can be used as a prompt for the user, and the user can also use the entrance to trigger the browser to display the page element.

The pre-configured type of the page element may be included in the browser's configuration parameter. The browser may set this parameter by default, or the user may manually set the parameter. For example, if the user wants to display image elements, the user can set the corresponding configuration parameter as image-type element. Further, multiple types may be set at the same time as the configuration parameter, such as both the video-type and the image-type, etc.

In certain embodiments, the browser might not need to identify types of the page elements and may only provide the user with corresponding entrances to present various page elements in the web page. For example, when the user moves the mouse over page elements, an entrance may be provided to the user to individual page elements. The user can selectively click on the entrance of any page element based on the user's needs or interest. The browser receives the user's request to display a page element through the entrance, determines that the page element requested by the user is the target page element, and performs subsequent operations. Thus, the browser does not have to identify the types of the page elements, further reducing system overhead. From the user's point of view, the page elements are not limited to only pre-configured types and, thus, the flexibility is increased.

It should be noted that various methods may be used to determine specific types of page elements. For example, one of the methods can be: in the process of moving the mouse by the user, relevant information of certain types of page elements under the mouse can be obtained by using function(s) provided by the browser. Such information may include tag, type, name, class identifier ClassID, and parent node, etc., of the page elements. The type of the page element can then be determined based on such information. For example, if a page element has a tag of <img>, the type of the page element may be determined as an image-type; if a page element has a tag of <object>, the ClassID of the page element may be further checked to determine whether the page element is an audio/video player embedded in the web page and to further determine whether the page element is an audio or video element, etc.

Another method for determining the type of page elements can be: analyzing the request sent by the browser to the server when loading the web page or the data sent by the server in response to determine the type of page elements. This method can identify all types of page elements with high accuracy, especially when the data portion of the response returned by the server is analyzed to identify the page elements.

After the target page element in the web page is determined (S201), processor 122 may present or display the target page element in the browser window of the web page at a fixed position relative to the browser window (S202). That is, the target page element is presented or displayed in an area relatively fixed to the browser window. In this presentation mode, it appears that the page element is floating on the original page window, so-called the floating presentation. With the floating presentation, the target page element does not move away from the viewable area of the browser window even when the scroll bar is scrolling the web page.

The page window often is a child window of the browser window. In addition to the page window, the browser window may also include other child windows, such as the toolbar.

The contents in a window are not just the contents currently displayed in the window. Similar to looking through a real glass window to view the scenery, the scenery may be infinite, but one can only see the part of the scenery with the same size as the glass window, which is called a viewable area. Thus, back to the browser window, the window area of the contents that are viewable by the user is the viewable area of the window. If the contents to be displayed in the window are more than the contents that can be displayed in the viewable area, a scroll bar(s) may appear at the right side and/or the bottom side of the window such that the contents displayed in the viewable area of the window can be changed by dragging the scroll bar.

Typically, a page element in a web page is displayed in a fixed position relative to its parent node, and the parent node is also in the page. Thus, the position of the page element is also fixed relative to the page window. When the scroll bar scrolls, the page scrolls and the page element also scrolls together.

However, when the page element is presented in the browser window at a fixed position relative to the browser window, the position of the page element is fixed relative to the original browser window. Although, when the scroll bar scrolls, the page containing the page element scrolls together, the page element remains in a fixed position relative to the browser window. In this way, the page element does not move out of the viewable area (e.g., out of the user's sight) because of the scrolling motion of the scroll bar. Thus, from the presentation point of view, the target page element looks like floating in the browser window. The user can browse other contents of the web page while viewing the page element, resulting in an improved resource utilization rate.

After the target page element is presented in the browser window at the fixed position relative to the browser window, the number of total windows does not change. That is, the target page element still belongs to the original web page, even though there are certain changes in the attributes of the target page element, and the movement of the target page element does not go beyond the scope of the original browser window. This may be different from presenting the page resources in an independent window.

For example, when a page resource is displayed in an independent window, the independent window may first need to be created with the desktop window as the parent window. That is, the independent window may be at the same level as the browser window, whose parent window is also the desktop window, or the independent window may be an opened known player. Thus, after the page resource is displayed in the independent window, the total number of windows can increase, and the page resource displayed in the independent window may no longer belong to the original web page.

Further, from the presentation point of view, after a target page element ‘a’ of the current web page ‘A’ is presented in the browser window at the fixed position relative to the browser window, when the user drags the browser window, the target element ‘a’ moves along with the browser window and maintains the same position relative to the browser window. In addition, if the current window focus is switched from web page ‘A’ to another web page ‘B’, or to another application, the target element ‘a’ is no longer viewable to the user. Also, if the browser window is closed, the target element ‘a’ disappears along with the browser window.

On the other hand, if target element ‘a’ is displayed in an independent window, the user can see a separate window independent from and in addition to the original browser window. When the user drags the browser window, the position of the independent window does not change. That is, the relative position between the original browser window and the independent window changes. In other words, the relative position between the independent window and the original browser window (i.e., the browser window of web page ‘A’) is not fixed. In addition, if the browser window is closed, the independent window displaying the target element ‘a’ may still exist and does not disappear along with the closure of the browser window.

It should be noted that, when a target page element is a video element, the video element may rely on a player embedded in the web page for presentation. Thus, when presenting the video element, the player may be displayed at the fixed position relative to the browser window to present the video element. That is, the player embedded in the web page may be considered as a page element. When a player is identified in the web page, it may be determined that a video or audio element exists in the web page and the player can then be displayed at the fixed position relative to the browser window.

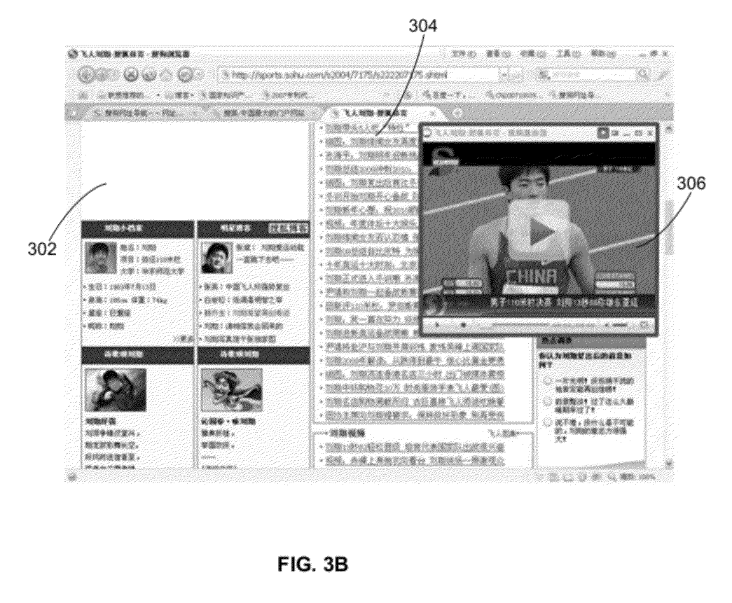

FIGS. 3A and 3B illustrate an exemplary video element presentation method. As shown in FIG. 3A, a video element in original position 302 in the browser window 304 is moved to a fixed position 306 relative to the browser window 304. The embedded player of the video element is also moved to the fixed position 306 relative to the browser window 304. The original position 302 becomes blank.

As shown in FIG. 3B, after the scroll bar scrolls downward, the contents of the web page move upward in the browser window 304. However, the video element remains unblocked in the fixed position 306, while only a portion of the original position 302 remains in the viewable area (i.e., the browser window 304).

A page element has a variety of attributes, including position, size, level, coordinate, and coordinate type, etc., of the page element. Among them, the coordinate may be used to indicate the specific location, and the coordinate type or position type refers to whether the coordinate or position is relative or absolute. These attributes of the page element are initially set by the original web page designer according to particular applications. However, the various attributes may be changed through document object model (DOM) operations provided by the browser. By modifying certain attributes of a page element, the page element may be displayed at a fixed position relative to the original browser window.

For example, the coordinate type or position type of the page element may be modified. That is, by directly configuring the position type of the page element, the page element can be presented at a fixed position relative to the browser window.

The coordinate type attribute (i.e., position type attribute) of a page element generally may be one of three types: relative, absolute, and fixed. A relative type means that the coordinate is relative to the parent node of the page element; an absolute type means that the coordinate is absolute with respect to the page window, and a fixed type means that the coordinate is fixed relative to the browser window. Ordinarily, when a page element is displayed in a web page, the coordinate type of the page element is relative, i.e., a fixed position relative to the parent node of the page element. Thus, when the scroll bar scrolls, the web page scrolls and the page element also scrolls along to maintain the relative position with the parent node. However, the relative position between the page element and the browser window changes. Because the user can see only the contents within the scope of the viewable area of the browser window, when the page element in the page scrolls out the scope of the viewable area of the browser window, the user may be unable to see the page element.

Thus, one way to display the page element in the browser window at a fixed position relative to the browser window is: directly setting the position type of the page element to fixed type (position=fixed), i.e., the coordinate is fixed relative to the browser window. That is, the position of the page element may change with respect to the page, but remains unchanged with respect to the browser window. Thus, when the scroll bar scrolls, the page element remains in the viewable area of the browser window displaying the page.

For example, for a target page element with original coordinate of (300, 400) and with a default position type of the relative type, when the scroll bar does not move, the target page element's coordinate relative to the browser window may also be (300, 400). After the position type is set to the fixed type, the target page element's coordinate relative to the browser window will be kept unchanged. Thus, when the scroll bar scrolls, the target page element is still displayed at the fixed position relative to the browser window, i.e., the position with the (300, 400) coordinate. Of course, in this case, the target page element's position relative to the original page window may have changed.

However, when only the position type of the page element is changed, the coordinate of the page element does not change. For example, if the page element is displayed at the center of the display screen before changing the position type, the page element is still displayed at the center of the display screen after changing the position type and remains being displayed at the center of the display screen even when the scroll bar scrolls.

Optionally, the attribute values of the coordinate(s) of the target page element can also be modified to display or present the target page element at a fixed specified location relative to the browser window of the current web page. For example, when changing the coordinate type of target page element, the attribute values, such as the values of the top coordinate and the left coordinate, etc., can also be set at the same time. Thus, after setting the coordinate of the target page element to the upper left corner of the browser window of the web page, the target page element will be displayed at the fixed location of the upper left corner of the browser window of the web page. Even when the scroll bar scrolls, the target page elements still is displayed at the upper left corner of the browser window of the web page.

Another way to change the position type of the target page element is: setting the position type of the page element to the absolute type, i.e., the absolute coordinate relative to the page window. However, when the absolute coordinate is used and the scroll bar scrolls, the page window may scroll along with the scroll bar, and the page element may also scroll together with the page window. That is, although the relative position between the page element and the page window remains unchanged, the relative position between the page element and the browser window may change. Thus, certain processing may be added to cause the page element displayed at a fixed position relative to the browser window.

For example, for a target page element with original coordinate of (0, 400) and with the position type changed to the absolute type, when the scroll bar does not move, the target page element's coordinate relative to the browser window may be (0, 500). If the scroll bar scrolls down by an offset value 300, the page element's coordinate relative to the browser window changes to (0,200), because the page element remains in a fixed position relative to the page window. Thus, the relative position between the page element and the browser window changes and it is equivalent to moving the page element upwards in the browser window by 300 pixels. Similarly, if the scroll bar scrolls down by an offset of 600, the page element's coordinate relative to the browser window changes to (0, −100). At this point, the page element has been moved out of the viewable area of the browser window partially or entirely. Thus, the user may be unable to view the page element normally.

Therefore, according to the disclosed embodiments, the scroll bar is monitored in real-time. When the scroll bar scrolls, the offset value of the scroll bar is first calculated. Based on the calculated offset, the coordinate of the page element relative to the page window is updated such that the page element still remains at the fixed position relative to the browser window. Alternatively, an event connector to the page window may be created. When a scroll bar scrolling event occurs, the browser is notified and the offset value of the scroll bar is calculated. Still assuming that the original coordinate of the page element is (0,400), if the scroll bar scrolls down with an offset value 300, the coordinate of the page element is increased by the offset value to (0, 700) in order to remain at a fixed position relative to the browser window.

Similarly, other attributes of the coordinate of the target page element can also be modified, such as the top value and the left value, etc. For example, the coordinate of the target page element of a web page can be set to the upper left corner of the page window of the page, and the target page element will be displayed on the upper left corner of the page window. Of course, when the scroll bar scrolls, the coordinate of the target page element also needs to be modified to remain at a fixed position relative to the browser window.

Further, the size attribute of the page element may also need to be considered. When a web page is created, the size of a page element can be represented in the absolute size, such as 300×300, or can be represented in the relative size with respect to the parent node, such as 100%. The absolute size reflects the actual size of the page element, while the relative size only reflects the size relative to the parent node. For example, if the parent node of a page element has a size of 300×300 and the relative size of the page element is 100%, the absolute size of the page element is 300×300.

However, after the coordinate type of the page element is changed, the relationship between the parent node and the page element may also change. If the size of the page element is still the relative size, the size of the page element may be different from the size of the page element in the original page. For example, if the coordinate type of the page element is modified to the absolute, i.e., absolute relative to the page window, the parent node of the page element may become the page window. If 100% is still used to represent the size of the page element, the size of the page element may become the same as the entire page window.

Therefore, according to the disclosed embodiments, if the size of the target page element is represented in the relative size, the size type of the target page element may be changed to the absolute size such that the size of the target page element can remain consistent with the original size of the target page element. Further, information such as the size type of the page element, the value of the relative size, and the size of the parent node, etc., is part of the attributes of the page element, and can be obtained using functions provided by the browser.

In addition, because the various page elements may be at different layers or levels, if only coordinate or coordinate type of the page element is changed, the page element may still be unable to be displayed to the user if the level of the page element is lower and is blocked by other page elements from higher levels. Thus, in certain embodiments, the level of the target page element may be changed to the highest level to ensure that the target page element is not blocked by other page elements from different levels.

Of course, after the level of the target page element is changed to the highest level, the target page element may block some of other page elements in the original page. For example, when the target page element is displayed at the upper left corner of the browser window, certain other page elements originally displayed at the upper left corner of the browser window will be obscured by the target element. However, because the user may pay more attention to the target page element and can also use the scroll bar to move the obscured page elements into unblocked viewable area, such level change may be acceptable or desired for the user.

Alternatively, the layout of other page elements in the page may be adjusted according to the target page element. For example, when the target page element is displayed at the upper left corner, other page elements can all be shifted to the right, so that the target page element is not blocking other page elements. Or other page elements may be adjusted to locations surrounding the target page element. For example, if the upper left corner, where the target page element is displayed, originally displays some texts, these texts can be adjusted such that the texts surround the target page element, while other page elements are not adjusted. Other methods may also be used.

In addition to directly changing the position type of the target page element, other processing may also be used based on different characteristics and attributes of the target page element. For example, the target page element may be in an iframe frame. Changing coordinate or coordinate type may be insufficient to display at a fixed position relative to the browser window. Other processing may be performed.

An iframe frame, also known as a floating frame tag, can be used to embed one HTML file into another HTML file for display. In other words, one web page can be embedded into another web page. By using the iframe frame, the one referred HTML file is not independently displayed with respect to the other HTML file. Rather, the one referred HTML file is embedded directly in the other HTML file and the contents of the one referred HTML file are integrated with the contents of the other HTML file to form a whole entity.

For example, if a tutorial page is separated into multiple pages for display, each separate page has a “Previous” link and/or a “Next” link at the end of the page. For the contents of the separate pages, however, each page may have many identical contents except different tutorial contents. Thus, when the “Previous” link or the “Next” link is clicked to display different pages, the identical contents of these pages have to be reloaded every time a different page is displayed. The resource utilization and the efficiency may be affected.

On the other hand, if the iframe frame structure is used, the contents of the tutorial can be separated into different content pages, which contain only the tutorial contents without other contents. The tutorial contents are placed into the iframe frame. Thus, when the “Previous” link or the “Next” link is clicked, only the tutorial contents are changed, and other contents remain unchanged. The identical contents for the previous different pages only need to be loaded once.

If a web page ‘B’ is embedded in a web page ‘A’, for the web page ‘A’, the contents of the web page ‘B’ are in the iframe frame. The iframe frame is also a page element, with an HTML tag <iframe>. Thus, if the HTML file of a web page contains an <iframe> tag, an iframe frame exists in the web page.

For the page elements included in the iframe frame, the movement range of the page elements is controlled within the iframe frame. That is, if the iframe frame is a window-type, the iframe frame of the web page ‘A’ is equivalent to a browser window with respect to the page window of the web page ‘B’. Thus, for the web page ‘B’ embedded in the iframe frame of web page ‘A’, when the target page element is in the web page ‘B’, directly changing the position type of the target page element in the web page ‘B’ to <absolute> makes the target page element to use absolute coordinate relative to the page window of the web page ‘B’; and directly changing the position type of the target page element in the web page ‘B’ to <fixed> makes the target page element to use coordinates relative to the iframe frame containing the web page ‘B’. Thus, directly changing the position type and/or coordinate of the target page element in the web page ‘B’ cannot cause the target page element displayed at a fixed position relative to the page window of the web page ‘A’ or relative to the browser window.

Therefore, when a target page element is identified in the web page ‘A’ and it is determined that the target page element is in the iframe frame (i.e., the target page element is actually also in the web page ‘B’), the position type of the iframe frame may be changed to <fixed> relative to the browser window, or the position type of the iframe frame may be changed to <absolute> relative to the page window of the web page ‘A’. Further, when scroll bar scrolls, the offset can also be calculated to update the coordinate value of the iframe frame to ensure the target page element is displayed at a fixed position relative to the browser window.

Further, other attributes of the iframe frame can also be modified to place the iframe frame at a specified location of the browser window. For example, if the size type of the iframe frame is a relative size, the size type of the iframe frame may be modified to an absolute size; if the iframe frame is not at the highest level when the web page has different levels, the level of the iframe frame may be modified to the highest level to avoid being blocked by other contents at higher levels; and so on.

As mentioned above, the iframe frame is also a page element whose attributes can be modified. In addition, the page elements in the iframe frame can also obtain information about the mouse movement, and obtain attribute information of the page elements from functions provided by the browser, such as size, location, and parent node, etc. Based on the information on the parent node, it can be determined whether a particular page element is in the iframe frame. Under certain circumstances, multiple levels of parent nodes may be used to decide whether the page element is in the iframe frame. For example, if a page element has a parent node with the tag <iframe>, it can be determined that the page element is in the iframe frame; if the page element has a parent node with the tag <div>, and its parent node (i.e., the second-level parent node) has the tag <iframe>, it can also be determined that the page element is in the iframe frame.

Further, when the attributes of the iframe frame are modified to place the iframe frame at a fixed position relative to the browser window, all contents in the iframe frame are displayed at the fixed position relative to the browser window. If only the target page element is to be displayed at the fixed position relative to the browser window, without displaying other page elements at the same time, certain configurations may need to be performed, such as moving and/or resizing the iframe frame.

When the iframe frame is resized to fit only the target page element, the resizing operation may need a coordinate as the reference base, such as using the upper left corner of the iframe frame as the base for resizing. However, after the iframe frame is resized based on the upper left corner, only those contents at the upper left corner of the iframe frame can be displayed. Therefore, to display only the target page element in the iframe frame, the coordinate type and/or the coordinate of the target page element can be modified to move the target page element to the upper left corner of the iframe frame. Further, the size of the iframe frame is changed to the same size as the target page element. Thus, only the target page element is displayed in the iframe frame.

More particularly, to move the target page element to the upper left corner of the iframe frame, the coordinate type of the target page element may be modified to <absolute> or <fixed> and the coordinate of the target page element is modified to (0,0). Of course, the size type and/or level of the target page element may also be modified, as previously described, details of which are omitted.

Such resizing operation may be applicable to both window-type and non-window-type iframe frames. However, when the iframe frame is non-window-type and the size of the iframe frame is reduced, a scroll bar may appear in the iframe frame. Thus, the scroll bar may be moved manually or automatically (e.g., the scroll bar position or offset position may be configured) to display the target page element in the iframe frame.

Thus, if the web page ‘B’ is embedded in the web page ‘A’ using an iframe frame, when a page element ‘x’ is identified in the web page ‘A’ and the page element ‘x’ is also in the iframe frame, the page element is actually also a page element in the web page ‘B’. If the iframe frame is non-window-type, the iframe frame is equivalent to the page window of the web page ‘B’. At this time, if the size of the iframe frame is reduced, only the upper left corner part of the web page ‘B’ can be displayed. Meanwhile, scroll bars may appear on the right and bottom of the web page ‘B’, and the scroll bars can be used to move the target page element into the iframe frame for display.

On the other hand, when the iframe frame is window-type, it is equivalent that the iframe frame window is the parent window of the page window having the target page element. The page window containing the target page element may be moved such that the target page element is displayed in the iframe frame.

That is, when the web page ‘B’ is embedded in the web page ‘A’ using an iframe frame, a page element ‘x’ is identified in the web page ‘A’ and the page element ‘x’ is also in the iframe frame, the page element is actually also a page element in the web page ‘B’. If the iframe frame is window-type, the page window of the web page ‘B’ is equivalent to a child window of the iframe frame window. Because a child window may be moved to change the relative position between the parent window and the child window, the page window of the web page ‘B’ can be moved to change the contents displayed in the iframe frame window, until the target page element is displayed in the iframe frame window. Of course, these operations may also be performed by the browser.

In addition, the user may be able to adjust the size and location, etc., of the target page element based on the user's preferences. For example, the attributes of a target page element and/or the iframe frame may be configured by the user to achieve the resizing of the target page element, or the target page element or the iframe frame may be dragged by the user to change the location of the target page element, and so on.

When the trigger event for dragging the target page element occurs, the coordinates of the target page element may be modified to move the target page element. The user may drag the target page element using a mouse, a keyboard, or other type of device. The mouse or keyboard may be used to illustrate such operations, and other devices may be similarly used.

When the keyboard is used, certain keys for the moving operation may be configured in advance. For example, these keys may be the “Up”, “Down”, “Left”, and “Right” keys or other keys. The moving direction and moving distance corresponding to individual keys being pressed may also be configured in advance. Thus, after it is determined that any pre-configured key(s) is pressed by the user, the target page element can be moved based on pre-configured rules.

More specifically, the user may select the target page element or iframe frame that needs to be moved, and the browser can then respond to the “onkeydown”, “onkeyup”, or “onkeypress” event of the selected target page element or iframe frame. The “onkeydown” event happens when the user presses any key on the keyboard including system keys, such as the arrow keys and function keys; the “onkeyup” event happens when the user releases any previously pressed key; and the “onkeypress” event happens when the user presses and releases any alphanumeric key.

When any of the events occurs, the key pressed can be determined. If the pressed key is one of the pre-configured keys, the selected target page element or iframe frame can be moved according to pre-configured rules. For example, if the rule is pre-configured to move 10 pixels each time the key is pressed, and the moving direction is pre-configured to the same as the direction on the key, when the user presses the “Down” key, the selected page element or iframe frame is moved down by 10 pixels. Accordingly, the coordinate of the top of the page element or iframe frame is increased by 10.

On the other hand, when a mouse is used, the user may place the mouse cursor on the page element or iframe frame that needs to be moved. The browser can then respond to mouse events of the target page element or iframe frame, such as the “onmousedown”, “onmousemove”, and “onmouseup” events. The “onmousedown” event happens when a mouse button is pressed; the “onmousemove” event happens when the mouse cursor moves; and the “onmouseup” event happens when the mouse button is released.

When the “onmousedown” event occurs, the selected page element or iframe frame is tracked by using the “setCapture” function (a function used in the specified window of the current thread to set the mouse capture). When the “onmousemove” event occurs, the offset between the current mouse cursor position and the previous mouse cursor position is obtained, and the offset is added to the coordinate of the selected page element or iframe frame to obtain new coordinate of the selected page element or iframe frame. The new coordinate can then be set as the coordinate of the selected page element or iframe frame. Further, when the “onmouseup” event occurs, the mouse tracking of the selected page element or iframe frame is released by using the “releaseCapture” function. The “releaseCapture” function is used to release the mouse capture from a window of the current thread and to resume normal mouse input processing.

Of course, after the iframe frame containing the target page element is displayed at a fixed position relative to the browser window, the user can drag the iframe frame to move the target page element. When the trigger event for dragging the iframe frame occurs, the browser may modify the coordinate of the iframe frame to move the iframe frame and to move the target page element.

In addition, if multiple page elements are identified in a same web page, or the user specified multiple page elements to be displayed, the multiple page elements can be respectively displayed at fixed positions relative to the browser window. For example, if there are two forms or two pictures in a web page, and the user needs to compare them, the user can choose to display the first form or first picture at a fixed position relative to the browser window, and then to move the first form or picture to a position of a second form or picture to perform comparison operations.

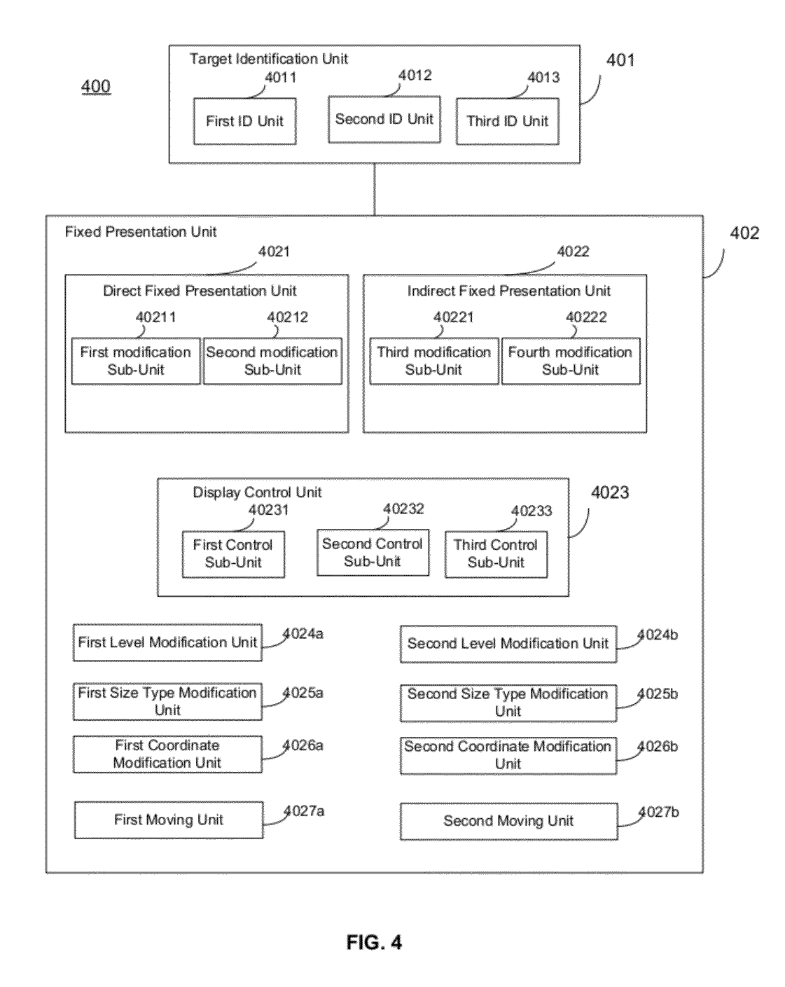

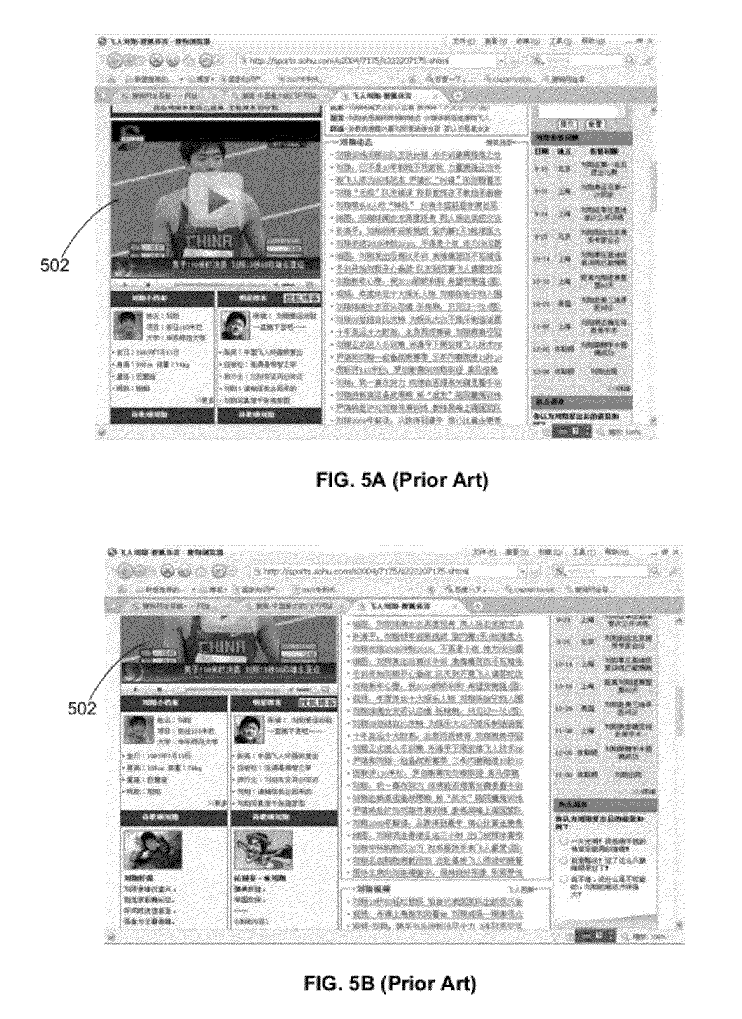

FIG. 4 illustrates an exemplary page element presentation system 400 consistent with the disclosed embodiments. Page element presentation system 400 may be implemented by hardware, software, or a combination of hardware and software, such as processor 122 and/or the browser software. Any appropriate implementation may be used.

As shown in FIG. 4, presentation system 400 includes a target identification unit 401 and a fixed presentation unit 402. The target identification unit 401 is configured to identify a target page element in a web page, and the fixed presentation unit 402 is configured to present or display the target page element in the browser window of the web page at a fixed position relative to the browser window.

Further, the fixed presentation unit 402 may include a direct fixed presentation unit 4021, an indirect fixed presentation unit 4022, a display control unit 4023, a first level modification unit 4024a, a first size type modification unit 4025a, a first coordinate modification unit 4026a, a first moving unit 4027a, a second level modification unit 4024b, a second size type modification unit 4025b, a second coordinate modification unit 4026b, and a second moving unit 4027b. Certain units may be omitted and other units may be added.

The direct fixed presentation unit 4021 is configured to directly change the position type of a target page element to present or display the target page element at a fixed position relative to the browser window. The direct fixed presentation unit 4021 may further include a first modification sub-unit 40211 and a second modification sub-unit 40212.

The first modification sub-unit 40211 may be configured to change the position type of a target page element to <fixed> relative to the browser window. The second modification sub-unit 40212 may be configured to change the position type of a target page element to <absolute> relative to the page window of the web page containing the target page element. The second modification sub-unit 40212 may also be configured to calculate the offset value of the scroll bar when the scroll bar scrolls and to adjust the coordinate of the target page element based on the offset value.

Further, the first level modification unit 4024a may be configured to change the level of the target page element to the highest level to prevent the target page element from being blocked by other page elements from different levels.

When the size of the target page element is represented in the relative size with respect to its parent node, if the size attribute of the page element is still the relative size, the size of the page element may be different from the size of the page element in the original page. The first size type modification unit 4025a may be configured to change the size type of the target page element to the absolute size.

The first coordinate modification unit 4026a may be configured to modify the coordinate of the target page element such that the target page element is moved or displayed at a specified location in the browser window. Further, after the target page element is displayed at a fixed position relative to the browser window, to enable the user to drag the target page element using a mouse or keyboard, the first moving unit 4027a may be configured to modify the coordinate of the target page element to move the target page element to the specified location when the trigger event of dragging the target page element occurs.

Further, when the target page element is in a iframe frame, the indirect fixed presentation unit 4022 may be configured to modify the position type of the iframe frame to display the iframe frame at a fixed position relative to the browser window and, thus, to indirectly display the target page element at the fixed position relative to the browser window.

Because there may be other page elements in the iframe frame in addition to the target page element, display control unit 4023 may be configured to display only the target page element in the iframe frame. The display control unit 4023 may further include a first control sub-unit 40231, a second control sub-unit 40232, and a third control sub-unit 40233.

The first control sub-unit 40231 may be configured to modify the size of the iframe frame to the same as the size of the target page element and to modify the coordinate type and the coordinate of the target page element to display the target page element at the resizing reference base of the iframe frame, such that only the target page element may be displayed in the iframe frame.

When the iframe frame is non-window type, the second control sub-unit 40232 may configured to modify the size of the iframe frame to the same as the size of the target page element and to move the scroll bar of the iframe frame, such that only the target page element may be displayed in the iframe frame.

Further, when the iframe frame is window type, the third control sub-unit 40233 may be configured to modify the size of the iframe frame to the same as the size of the target page element and to move the page window containing the target page element in the iframe frame, such that only the target page element may be displayed in the iframe frame.

Similar to the direct fixed presentation unit 4021, the indirect fixed presentation unit 4022 may further include a third modification sub-unit 40221 and a fourth modification sub-unit 40222.

The third modification sub-unit 40221 may be configured to change the position type of the iframe frame to <fixed> relative to the browser window and to set the coordinate of the iframe frame to a specified location relative to the browser window. The fourth modification sub-unit 40222 may be configured to change the position type of the iframe frame to <absolute> relative to the page window of the web page containing the target page element and to set the coordinate of the iframe frame to a specified location relative to the page window. The fourth modification sub-unit 40222 may also be configured to calculate the offset value of the scroll bar when the scroll bar scrolls and to adjust the coordinate of the iframe frame based on the offset value.

Further, the second level modification unit 4024b may be configured to change the level of the iframe frame to the highest level. When the size of the iframe frame is represented in the relative size with respect to its parent node, the second size type modification unit 4025b may be configured to change the size type of the iframe frame to the absolute size.

The second coordinate modification unit 4026b may be configured to modify the coordinate of the iframe frame to cause the iframe frame displayed at a specified location in the browser window, such that the target page element is displayed at a fixed position relative to the browser window. Further, after the target page element is displayed at a fixed position relative to the browser window using the iframe frame, to enable the user to drag the target page element using a mouse or keyboard, the second moving unit 4027b may be configured to modify the coordinate of the iframe frame to move the iframe frame and the target page element to the specified location when the trigger event of dragging the iframe frame occurs.

Further, the target identification unit 401 may include a first identification unit 4011, a second identification unit 4012, and a third identification unit 4013. The first identification unit 4011 may be configured to identify a page element with a pre-configured type and to automatically determine the identified page element as the target page element.

The second identification unit 4012 may be configured to identify a page element with a pre-configured type and to provide the user with an entrance to the identified page element. Further, the second identification unit 4012 may be configured to receive a user request to display the identified page element and to determine the requested page element as the target page element.

The third identification unit 4013 may be configured to provide the user with respective entrances to individual page elements, to receive a user request to display a page element, and to determine the requested page element as the target page element.

The disclosed systems and methods may provide many advantageous browser and other software applications in a variety of network or client environments, such as in personal computer equipment and the like, mobile phones, mobile communication devices, personal digital assistants (PDAs) and other electronic equipment. Other applications and advantages are obvious to those skilled in the art.

What is claimed is:

1. A method for presenting page elements on a computer having a browser for a user of the computer, comprising:
identifying a page element in a web page displayed in a browser window of the browser as a target page element;
modifying a coordinate type of the target page element; and
presenting the target page element at a fixed position relative to the browser window based on the modified coordinate type.

2. The method according to claim 1, further including: modifying a coordinate of the target page element; wherein presenting the target page element further includes:
presenting the target page element at a specified location relative to the browser window based on the modified coordinate.

3. The method according to claim 1, wherein modifying the coordinate type of the target page element further includes one of:
modifying the coordinate type of the target page element to a fixed type relative to the browser window; and
modifying the coordinate type of the target page element to an absolute type relative to a page window of the web page, calculating an offset value of a scroll bar when the scroll bar scrolls, and modifying a coordinate of the target page element based on the offset value.

4. The method according to claim 1, further including:
change a level of the target page element to the highest level.

5. The method according to claim 1, further including:
when a size type of the target page element is a relative size with respect to a parent node of the target page element, changing the size type of the target page element to an absolute size type.

6. The method according to claim 1, wherein the trigger event is dragging the target element, and presenting the target page element further includes:
modifying a coordinate of the target page element to move the target page element to the specified location in the browser window.

7. The method according to claim 1, wherein the target page element is in an iframe frame of the web page and modifying the coordinate type of the target page element further includes:
modifying a coordinate type of the iframe frame to display the iframe frame at the fixed position relative to the browser window.

8. The method according to claim 7, further including:
modifying a size of the iframe frame to same size as the target page element, and modifying the coordinate type and a coordinate of the target page element to display the target page element at a resizing reference base of the iframe frame, such that only the target page element is displayed in the iframe frame;
when the iframe frame is a non-window type, modifying the size of the iframe frame to same size as the target page element and moving a scroll bar of the iframe frame, such that only the target page element is displayed in the iframe frame; or
when the iframe frame is a window type, modifying the size of the iframe frame to same size as the target page element and moving the page window containing the target page element in the iframe frame, such that only the target page element is displayed in the iframe frame.

9. The method according to claim 7, wherein modifying the coordinate type of the iframe frame to display the iframe frame at the fixed position relative to the browser window further includes:
modifying the coordinate type of the iframe frame to a fixed type relative to the browser window and setting a coordinate of the iframe frame to the fixed position relative to the browser window; or
modifying the coordinate type of the iframe frame to an absolute type relative to a page window of the web page, setting the coordinate of the iframe frame to the fixed position relative to the browser window, calculating an offset value of a scroll bar when the scroll bar scrolls, and updating the coordinate of the iframe frame based on the offset value.

10. The method according to claim 7, further including:
change a level of the iframe frame to the highest level.

11. The method according to claim 7, further including:
when a size type of the iframe frame is a relative size with respect to a parent node of the iframe frame, changing the size type of the iframe frame to an absolute size type.

12. The method according to claim 7, further including: modifying a coordinate of the iframe frame; wherein presenting the iframe frame at the fixed position relative to the browser window further includes:
presenting the iframe frame at a specified position relative to the browser window further.

13. The method according to claim 7, wherein the trigger event is dragging the iframe frame, and presenting the target page element further includes:
modifying a coordinate of the iframe frame to move the iframe frame to the specified location in the browser window such that the target page element is indirectly moved to the specified location in the browser window.

14. The method according to claim 1, wherein identifying the target page element further includes:
identifying a page element with a pre-configured type and determining the identified page element as the target page element;
identifying the page element with the pre-configured type, providing the user with an entrance to the identified page element, receiving a user request to display the identified page element, and determining the requested page element as the target page element; or
providing the user with respective entrances to individual page elements in the web page, receiving a user request to display a page element, and determining the requested page element as the target page element.

15. A system for presenting page elements to a user using a browser, comprising:
a target identification unit configured to identify a page element in a web page displayed in a browser window of the browser as a target page element; and
a fixed presentation unit configured to:
modify a coordinate type of the target page element; and
present the target page element at a fixed position relative to the browser window based on the modified coordinate type.

16. The system according to claim 15, wherein the fixed presentation unit is further configured to:
a first coordinate modification unit configured to modify the coordinate of the target page element to present the target page element at a specified location relative to the browser window based on the modified coordinate.

17. The system according to claim 15, wherein, to modify the coordinate type of the target page element, the fixed presentation unit further includes one of:
a first modification sub-unit configured to modify the coordinate type of the target page element to a fixed type relative to the browser window; and
a second modification sub-unit configured to modify the coordinate type of the target page element to an absolute type relative to a page window of the web page, to calculate an offset value of a scroll bar when the scroll bar scrolls, and to modify a coordinate of the target page element based on the offset value.

18. The system according to claim 15, wherein the fixed presentation unit further includes:
a first level modification unit configured to change a level of the target page element to the highest level.

19. The system according to claim 15, wherein the fixed presentation unit further includes:
a first size type modification unit configured to, when a size type of the target page element is a relative size with respect to a parent node of the target page element, change the size type of the target page element to an absolute size type.

20. The system according to claim 15, wherein the trigger event is dragging the target element and, to move the target page element, the fixed presentation unit further includes:
a first moving unit configured to modify a coordinate of the target page element to move the target page element to the specified location in the browser window.

21. The system according to claim 15, wherein the target page element is in an iframe frame of the web page and, to modify the coordinate type of the target page element, the fixed presentation unit is further configured to:
modify a coordinate type of the iframe frame to display the iframe frame at the fixed position relative to the browser window.

22. The system according to claim 21, wherein the fixed presentation unit further includes a display control unit configured to display only the target page element in the iframe frame and the display control unit further includes:
a first control sub-unit configured to modify a size of the iframe frame to same size as the target page element and to modify the coordinate type and a coordinate of the target page element to display the target page element at a resizing reference base of the iframe frame, such that only the target page element is displayed in the iframe frame;
a second control sub-unit configured to, when the iframe frame is a non-window type, modify the size of the iframe frame to same size as the target page element and to move a scroll bar of the iframe frame, such that only the target page element is displayed in the iframe frame; or
a third control sub-unit configured to, when the iframe frame is a window type, modify the size of the iframe frame to same size as the target page element and to move the page window containing the target page element in the iframe frame, such that only the target page element is displayed in the iframe frame.

23. The system according to claim 21, wherein, to modify the coordinate type of the iframe frame to display the iframe frame at the fixed position relative to the browser window, the fixed presentation unit further includes:
a third modification sub-unit configured to modify the coordinate type of the iframe frame to a fixed type relative to the browser window and to set a coordinate of the iframe frame to the fixed position relative to the browser window; or
a fourth modification sub-unit configured to modify the coordinate type of the iframe frame to an absolute type relative to a page window of the web page, to set the coordinate of the iframe frame to the fixed position relative to the browser window, to calculate an offset value of a scroll bar when the scroll bar scrolls, and to update the coordinate of the iframe frame based on the offset value.

24. The system according to claim 21, wherein the fixed presentation unit further includes:
a second level modification unit configured to change a level of the iframe frame to the highest level.

25. The system according to claim 21, wherein the fixed presentation unit further includes:
a second size type modification unit configured to, when a size type of the iframe frame is a relative size with respect to a parent node of the iframe frame, change the size type of the iframe frame to an absolute size type.

26. The system according to claim 21, wherein the fixed presentation unit further includes:
a second coordinate modification unit configured to modify a coordinate of the iframe frame to move the iframe frame to the specified location in the browser window such that the target page element is indirectly moved to the specified location in the browser window.

27. The system according to claim 21, wherein the trigger event is dragging the iframe frame and, to move the target page element, the fixed presentation unit further includes:
a second moving unit configured to modify a coordinate of the iframe frame to move the target page element to the specified location in the browser window.

28. The system according to claim 15, wherein, to identify the target page element, the target identification unit further includes:
a first identification sub-unit configured to identify a page element with a pre-configured type and determining the identified page element as the target page element;
a second identification sub-unit configured to identify the page element with the pre-configured type, to provide the user with an entrance to the identified page element, to receive a user request to display the identified page element, and to determine the requested page element as the target page element; or
a third identification sub-unit configured to provide the user with respective entrances to individual page elements in the web page, to receive a user request to display a page element, and to determine the requested page element as the target page element.
